(19) United States
(12) Patent Application Publication
(10) Pub. No.: US 2009/0044776 A1
(43) Pub. Date: Feb. 19, 2009

(54) Ignition device for an internal combustion engine

(76) Inventors: Johann Klausner, St. Jakob i.H. (AT); Herbert Kopecek, Halbergmoos (DE); Georg Reider, Wien (AT)

Correspondence Address: WENDEROTH, LIND & PONACK, L.L.P., 2033 K STREET N. W., SUITE 800, WASHINGTON, DC, 20006-1021, US

(21) Appl. No.: 12/068,528

(22) Filed: Feb. 7, 2008

(30) Foreign Application Priority Data
Feb. 9, 2007 (AT) A 215/2007

(51) Int. Cl. F02P 23/04

(52) U.S. Cl. 123/143 B

(57) ABSTRACT

An ignition device with a laser light generating device for the coupling of laser light into a combustion chamber of the internal combustion engine, wherein the laser light generating device is configured to couple at least dichromatic laser light into a combustion chamber of an internal combustion engine.

The present invention relates to an ignition device for an internal combustion engine, in particular a gas engine, with a laser light generating device for the coupling of, in particular ignitable, laser light into a combustion chamber of the internal combustion engine. In addition, the invention relates to an internal combustion engine, in particular a gas engine, comprising an ignition device of this type.

In the prior art, in the laser ignition of combustible mixtures, usually a pulsed laser beam generates in the focus of a beam-concentrating lens such high field strength that the gaseous molecules are ionized and a plasma is produced. The two physical effects playing a crucial part in this process are referred to in the specialist literature as multiphoton ionization and the inverse bremsstrahlung effect. Both effects lead to the ionization of matter.

However, the generic ignition means known in the art have not yet been able to overcome the problem that it is technically difficult to provide cost-effectively and simply in the focus region sufficient energy to ignite the plasma.

The object of the invention is to provide a generic ignition means which provides in a cost-effective and energy-efficient manner the energy required in the focus for the purposes of ignition.

According to the invention, this is achieved in that the laser light generating device is configured to couple at least dichromatic laser light, preferably onto a common focus region, into the combustion chamber.

It is preferably provided that the at least dichromatic laser light has in its power spectrum at least two local maxima which are separated from one another with regard to their wavelength.

The invention is based, inter alia, on the recognition that multiphoton ionization and the inverse bremsstrahlung effect have markedly differing dependency on the wavelength of the causal laser radiation. Whereas multiphoton ionization is more apparent at short wavelengths, as these benefit from the higher photon energy, the inverse bremsstrahlung effect dominates at larger wavelengths. In addition, the pressure dependency of the formation of plasma differs in both effects. As a result of both, the laser energy required to generate an ignition spark is significantly dependent on the emission wavelength of the laser light generating device. In addition, it should be noted that short-wave light can be focused more effectively than long-wave light. For specific application, this means that, in the case of relatively short-wave light, if the same focusing optics is used, lower pulse energies are sufficient to reach the breakthrough threshold and thus to generate the laser spark. According to the state of prior knowledge, a plasma is not necessarily sufficient successfully to ignite the fuel/air mixture in the combustion chamber. This requires, depending on the composition of the mixture, the pressure and temperature conditions in the mixture and also on the flow state, additional laser energy which has to be supplied to the plasma. A basic idea of the invention is therefore to use for the purposes of ignition laser radiation consisting of at least two radiation components having differing wavelengths. In this case, short-wave radiation is, primarily for the above-mentioned reasons, chiefly responsible for the generation of the initial plasma, whereas long-wave radiation supplies the plasma with further energy and thus enlarges the spatial extent of the plasma. This latter aspect benefits the ignition of the fuel/air mixture. The advantage of this procedure during ignition is that the overall amount of laser energy required can be much less than is possible with a monochromatic laser light generating device, as in these means, which are known in the art, the wavelength dependency of the physical processes involved in the ignition cannot be positively utilized.

In principle, it is possible to generate dichromatic laser radiation by means of two independent laser light generating devices, although this has certain drawbacks on account of the very stringent requirements placed on the spatial and temporal synchronization of the two laser light generating devices. However, owing to the relatively high complexity and the costs associated therewith and also the susceptibility of the ignition system, this possible embodiment is somewhat second-rate. Much more beneficial is the approach which utilizes the frequency multiplication, in particular frequency doubling, or parametric frequency conversion known in the art. In this case, a medium having markedly pronounced non-linear optical properties, such as for example KTP (potassium titanyl phosphate), KDP (potassium dihydrogen phosphate), LiNBO₃ or BBO (β-barium borate, β-BaB₂O₄), can be used to convert by optical frequency multiplication or parametric conversion laser light into shorter-wave or longer-wave light. An example of this would be the conversion of infrared light having a wavelength of 1,064 nm (nanometer) into a green laser light at 532 nm. As the efficiency of these wavelength conversion processes is limited to approximately 50% if conventional technology is used, approx. half of the radiation energy in its original wavelength remains in the laser light, so the laser light which is irradiated as a whole is at least dichromatic. During the parametric conversion, the wavelength ratio can be set, in particular, by crystal orientation and/or the application of certain temperatures and/or other electrical fields and/or pressures to the medium having the markedly pronounced non-linear optical properties. One embodiment of the invention thus involves using a frequency-multiplied, in particular frequency-doubled, or parametrically converted laser light beam of this type, optionally in conjunction with the original beam, for the purposes of ignition. In order to obtain dichromatic light, in the laser light generating device the component of the laser beam having the original wavelength is not blocked but rather introduced, together with the newly generated component, into the combustion chamber of the engine. As both components originate in this embodiment from the same source, both beams run precisely along the same optical axis, thus obviating the need for external colinearization, which always involves additional costs, of both radiation components. The medium required for this purpose, which is usually in the form of crystal, having markedly pronounced non-linear optical properties increases the complexity of the system only slightly, especially as this medium can be arranged both inside and outside a laser resonator of the laser light generating device, thus also allowing a monolithic design of the resonator. Even the overall energy balance is, in the case of laser light generating devices for dichromatic laser light, no worse than for the previously used monochromatic laser since, as mentioned hereinbefore, both the converted and the unconverted wavelength components of the laser light are introduced into the combustion chamber. Additional losses are low and generally negligible. Non-linear frequency conversion is achievable for instance by methods of phase matching, known for example in literature as type I or type II or with periodically polarized non-linear media (known in literature for example as quasi phase matching).

Obviously, in the case of frequency multiplication, the two wavelengths entering the combustion chamber differ by the multiplication factor n (thus λ₁=nλ₂, n being a natural number ≧2), i.e. by a factor of 2 in the case of frequency doubling. Preferably the wavelengths are in a constant phase correlation to each other (mutual coherence). Furthermore preferably the relative phase phasing of the waves of the dichromatic laser light is adjusted by a dichroic phase lag disc (e.g. from glass) in the optical path 9 for optimizing the ignition process. Short wave and long wave laser light are adjustable relative to each other for the ideal ignition process. In this case it might be provided for that both waves have the same linear polarization, achieved for example by suitable birefringent discs. Furthermore, a lens or a lens system might be provided for focusing the laser light, the dispersion of the lens (system) being such that the wave lengths are focused in an ideal relative distance for ignition. In the case of parametric optical conversion, a photon produces at least two longer-wave photons. In this context, the conversion factor can in principle be freely selected. However, in order significantly to implement the aforementioned wavelength-dependent effects, it is beneficial to aim for a ratio of the wavelengths involved of at least 1 to 1.25, preferably measured in nanometres (nm), preferably the ration is at least 1 to 2. The spectral spacing of the two maxima or components should beneficially be greater than the greatest line width of the maxima at the respective half maximum amplitude. In the prior art, this line width is referred to as the FWHM (full width at half maximum) line width.

Particularly preferably, provision is made for a first of the at least two maxima to be in a wavelength range between 1 μm and 0.2 μm, preferably between 0.6 μm and 0.2 μm, and/or for a second of the at least two maxima to be in a wavelength range between 10 μm and 1 μm, preferably between 2.5 μm and 1 μm.

In principle, it is conceivable to provide in accordance with the invention a laser light generating device which continuously or almost continuously couples dichromatic laser light into the combustion chamber. However, it is preferable if the laser light generating device is configured to emit the at least dichromatic laser light in the form of at least one time-limited laser light pulse.

In addition, provision may also be made for the laser light generating device to be configured to emit at least two laser light pulses which are separated from one another in time and are per se limited in time, both laser light pulses having at least dichromatic laser light or the chronologically second laser light pulse having in its power spectrum at least one maximum which occurs at a wavelength different from, preferably greater than, the chronologically first laser light pulse.

For optimum utilization of the laser energy of the subsequent pulses, the delay, calculated between the maximum of the preceding pulse and the maximum of the subsequent pulse, between the pulses should be from 10 ns to 200 ns (nanoseconds), preferably from 30 ns to 70 ns. Within this delay, the radiation of subsequent pulses couples efficiently to the plasma provided of the preceding pulse without itself having to reach the high threshold intensity required for the formation of plasma. In the case of relatively long delays of more than 200 ns, the plasma is cooled to the extent that the laser radiation no longer couples and passes through the hot gas volume produced without the formation of plasma. In this case, the threshold intensity required for the formation of plasma is even higher than normal.

The laser light pulses beneficially have a relatively short duration. It is preferable in this case for the at least one laser light pulse or at least one, preferably each, of the at least two laser light pulses which are separated from one another in time to have a duration of between 0.1 ns and 3 ns, preferably between 0.1 ns and 0.1 ns.

Ignition devices of the described kind are used for example in internal combustion engines, in particular gas engines, but also in aircraft turbines or rocket engines.

Further details and features of the invention will be described hereinafter with reference to various exemplary embodiments according to the invention. In the drawings:

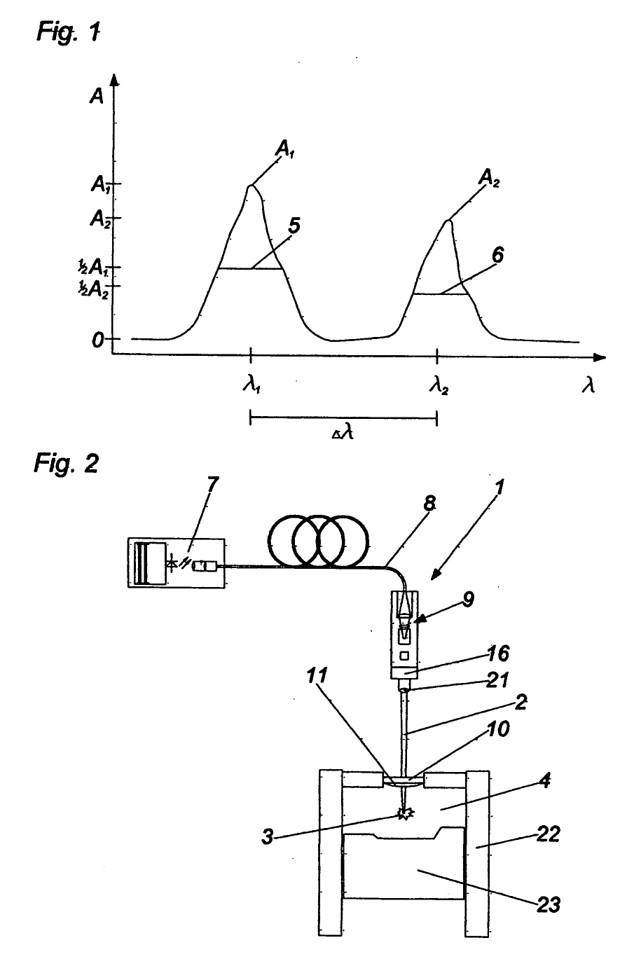

FIG. 1 shows by way of example a power spectrum of dichromatic laser light;

FIG. 2 shows schematically the basic elements of a laser light generating device according to the invention;

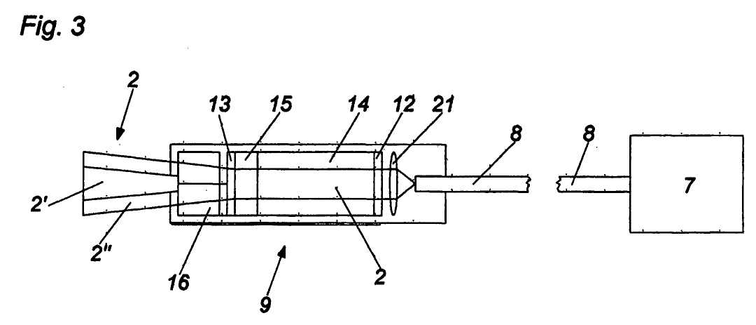

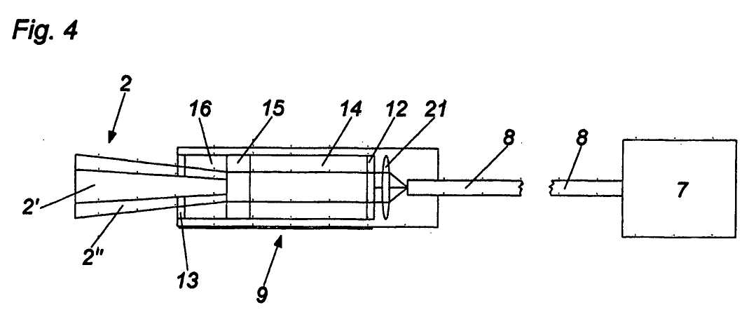

FIGS. 3 and 4 show various resonators suitable for generating dichromatic laser light;

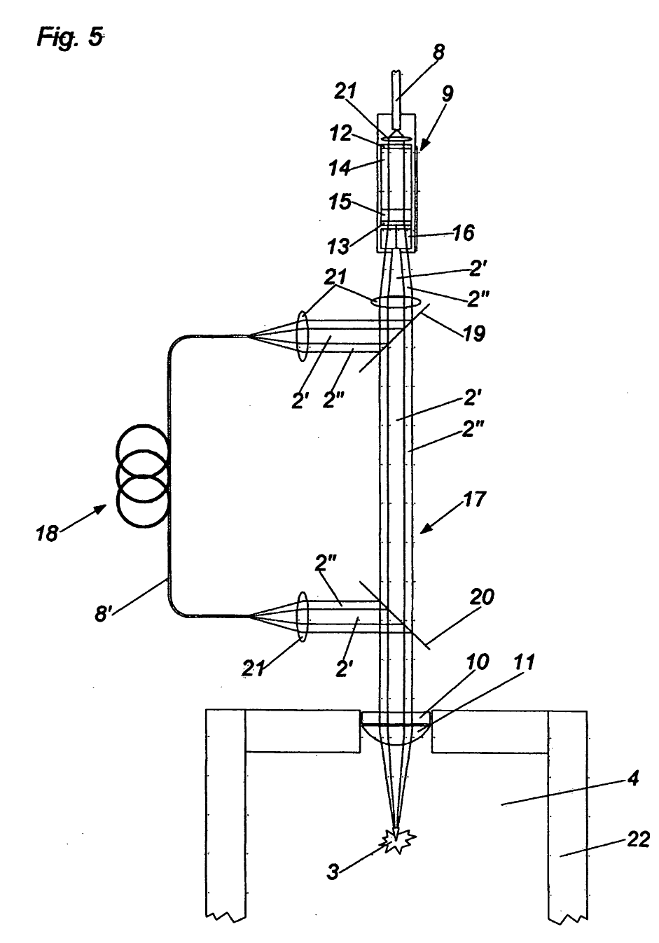

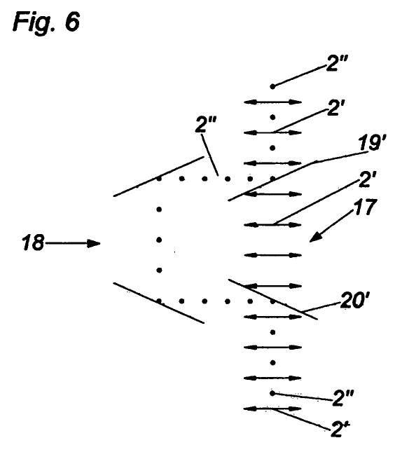

FIGS. 5 and 6 show exemplary embodiments for generating two laser light pulses according to the invention which are delayed with respect to each other;

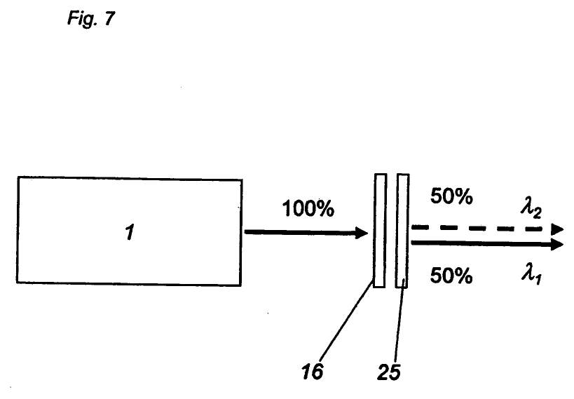

FIG. 7 shows schematically an arrangement for generating dichromatic laser light; and

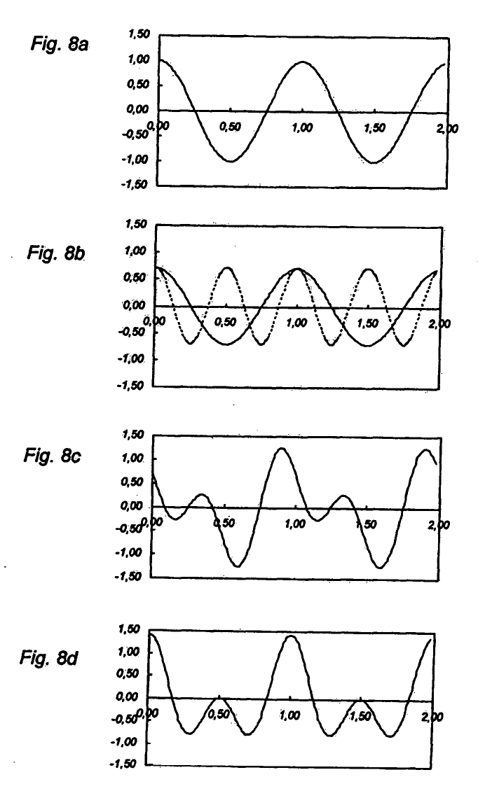

FIG. 8a to 8d show diagram of the field strengths as a function of time.

FIG. 1 plots by way of example the power spectrum A—calculated in a manner known per se—of a dichromatic laser light pulse according to the invention over its wavelength λ. The spectrum reveals two local maxima A₁ and A₂ which are separated from each other. The maximum A₁ occurs at the wavelength λ₁, the maximum A₂ at the wavelength λ₂. Also shown are the line widths 5 and 6 at the respective half maximum amplitude (½A₁ or ½ A₂). The line widths 5 and 6 are thus what are known as the FWHM (full width at half maximum) line widths. The wavelength spacing Δλ between the maxima A1 and A2 is in this case greater than both the line width 5 of the first maximum A₁ and the line width 6 of the second maximum A₂.

FIG. 2 shows a preferred embodiment of a laser light generating device 1 according to the invention. The laser light generating device has firstly—as is known per se—a pumped light source 7, e.g. a laser diode. The pumped light is fed into the resonator 9 via the optical fiber 8 or via another suitable optics. For parametric wavelength conversion or for frequency multiplication and, in particular, frequency doubling, a medium 16 having non-linear optical properties follows the resonator. The dichromatic laser light 2 thus generated is then coupled onto the focus region 3, into the combustion chamber 4, via the lens arrangement 21 of the combustion chamber window 10. The combustion chamber is located—as is known per se—in the cylinder 22 and is downwardly delimited by the piston 23. In the focus region 3, an initial plasma, which is enlarged by the long-wave laser light component and continues to be fed with energy until ignition occurs, is preferably generated by the short-wave component of the dichromatic laser light. In a particularly preferred variation, again, short-wave laser light can then in a final phase increase the energy content of the plasma to above the value which can be achieved by the long-wave laser light, a third wavelength-dependent effect being taken into account. This effect is the reflection of the laser light on the plasma as soon as the plasma exceeds a specific density known as the critical density (=number of free electrons per volume). This reflection prevents any further laser energy from being supplied to the plasma. However, the critical plasma density is dependent on the wavelength of the light. Thus, when the critical density has been reached for a specific wavelength, energy can still be introduced into the plasma at a shorter wavelength. If this is utilized, the short-wave component is first used to generate the initial plasma. Subsequently, the plasma is heated and enlarged with high efficiency by means of the long-wave component. This type of input of energy into the plasma ends when the critical plasma density is reached for this wavelength, after which energy can still be introduced by means of the short-wave laser light component. To optimize this process, the short-wave component can also be divided into two parts, one of which is used for the initial ignition of the plasma and the other after a suitable time delay, for example through a delay path, the delay duration of which should correspond substantially to the pulse duration of the radiation, as an afterburner pulse. A variation for first decoupling and then recoupling components of, or the entire, dichromatic laser light pulse onto a delay path 18 is shown in FIG. 6 and will be described hereinafter.

FIGS. 3 and 4 then show firstly how laser resonators 9 can be configured to generate dichromatic laser light according to the invention. In both variations, the laser resonators are what are known as longitudinally pumped laser resonators 9. However, this does not mean that other laser resonators, such as for example what are known as transversely pumped laser resonators, cannot be used in accordance with the invention.

In FIGS. 3 and 4, the pumped light originating from the pumped light source 7 is coupled into the laser-active medium 14 via the resonator coupling mirror 21 by means of the optical fiber 8 and the lens arrangement 21. In both embodiments, a Q-switch 15 follows—as is known per se—the laser-active medium 14. In the embodiment according to FIG. 3, the Q-switch 15 is followed, as is conventional, by the resonator decoupling mirror 13 and only then the medium 16 which has non-linear optical properties and is used for parametric wavelength conversion or frequency multiplication. In the embodiment according to FIG. 4, this medium 16 is arranged between the resonator decoupling mirror 13 and the Q-switch 15, i.e. integrated into the resonator 9. In both exemplary embodiments, a dichromatic laser light beam 2, which may but does not have to have components 2′ and 2″ having differing spatial distributions, leaves the medium 16 having non-linear optical properties. The division of the dichromatic laser light into the components 2′ and 2″, which are illustrated schematically in the present document, results from the differing focusing properties of the two components having various wavelengths. It should be noted in this regard that despite the differing focusing effects, the optical transmission means should be configured in such a way that in the focus region 3, in which the plasma is formed in the combustion chamber 4, the more markedly focused region is beneficially located within the less focused laser light component.

FIG. 5 then shows a preferred variation as to how two time-delayed laser light pulses can be generated from a dichromatic laser light pulse 2 generated by means of the laser resonator 9 according to FIG. 3. An optically shorter path 17, on which a portion of the laser light pulse is coupled directly into the combustion chamber 4, and a delay path 18 which is optically longer by comparison are provided for this purpose. A delayed decoupling mirror 19 which is semitransparent at least in certain regions is arranged in the course of the beam for decoupling a portion of the laser light pulse into the delay path 18. A portion of the laser light pulse is reflected on the delayed decoupling mirror and coupled into the optical fiber 8 via the lens arrangement 21. In the optical fiber, the laser light travels an optically longer path, and this leads to the desired delay. In order to direct even this laser light component into the focus region 3, provision may beneficially be made for this delayed laser light component to be recoupled onto the path 17 via the delayed coupling mirror 20 which is also semitransparent. Obviously, it would also be possible in a modification of this exemplary embodiment to couple the delayed laser light component into the focus region 3 via its own coupling optics (not shown in the present document) directly—i.e. without a delayed coupling mirror 20. Nevertheless, it is in principle beneficial to keep the number of combustion chamber windows 10 as low as possible, so the variation shown in the present document is preferred.

Depending on the configuration of the delayed decoupling mirror 19 and/or of the delayed coupling mirror 20, it is possible to guide in each case dichromatic laser light on the two paths or to feed into the combustion chamber 4 laser light components which have differing wavelengths and are delayed with respect to one another by means of the two paths. If the latter is intended, the differing focusing of the long-wave and the short-wave light component 2′ and 2″ can be utilized for separating the light wavelength components. For example, provision could be made for the delayed decoupling mirror 19 to divert, through regions having correspondingly differing transmission or reflection, only one of the two light components 2′ or 2″ via the delay path 18 and thus to delay it in time with respect to the other light wave component. This is also possible by way of correspondingly configured reflection properties and transmission properties of the delayed coupling mirror 20. As a result, it is possible to configure almost without restriction which light wave component enters the focus region 3 at which moment. Instead of the optical fiber 8, suitable mirror arrangements or the like can obviously also be used to generate the delay path 18. In addition, it is obviously also possible to use a plurality of delay paths 18 having differing optical wavelengths in order to generate a sequence of a plurality of laser light pulses. The light wavelength components of the individual pulses can then, in turn, be controlled by way of the reflection and transmission properties, which may differ in certain regions, of the mirrors 19 and 20 or the correspondingly additionally arranged delayed decoupling and coupling mirrors.

FIG. 6 shows schematically how the decoupling of a portion 2″ of the laser light into a delay path 18 is possible utilizing differing polarizations of the light components 2′ and 2″ by means of a polarization beam splitter. In this case, the content of the light component 2′ is—in the example shown in the present document, polarized substantially perpendicularly to the light component 2″. These differing polarizations can be generated by the non-linear optical processes in the medium 16 or by wavelength-dependent birefringent plates. The division into the components 2′ and 2″ is in any case carried out on the delayed decoupling mirror or polarization beam splitter 19, the component 2′ being transmitted and the component 2″ reflected. The two light components 2′ and 2″ are brought back together onto the same path by means of the delayed coupling mirror 20′. The remainder of the design then corresponds substantially to that shown in FIG. 5.

FIG. 7 shows schematically an arrangement for generating dichromatic laser light. The arrangement comprises a laser light generating device 1 emitting laser light L1 with a wave length λ₁ having an intensity of 100%. Subsequently, a medium 16 which has non-linear optical properties follows. (The medium 16 could be arranged inside the laser light generating device 1.) The medium 16 could for example duplicate the frequency so that dichromatic laser light one the one hand with wave length λ₁ of the initial laser light and on the other hand with wave length λ₂ of

$$\frac{{λ}_{1}}{2}$$

is emitted. In the shown example the intensities L1′ and L2′ after the medium 16 are 50% of the initial intensity L1. In addition, provision may also be made for a dispersive element 25 to adjust the relative phase of both parts of the laser light by a controlled phase lag of one part of the dichromatic laser light. This could be achieved for instance with a glass plate. A polarizing element (not shown), for example a birefringent plate, could—if required—adjust the polarisation of both parts of the light.

FIG. 8a to 8d show the field strength as a function of time each. FIG. 8a shows the field strength as emitted from the laser light generating device 1. FIG. 8b shows the field strength of λ₁ (full line) and λ₂ (dashed line) of the light as occurring after the medium 16. Even though the intensities are reduced to 50%, the amplitude of the field strength is reduced only by a factor of

$$\frac{1}{\sqrt{2}}$$

(to 70,7%). FIG. 8c shows the sum of the field strengths of FIG. 8b of λ₁ and λ₂ in comparison to the monochromatic light as emitted by the laser light generating device (FIG. 8a). As can easily be seen the field strengths add to maxima increased by approximately 20%. The higher field strengths in these maxima may result in better ignition behaviour. Whereas phasing of both parts of the light (λ₁, λ₂) is identical in FIG. 8c, there is a phase shift of 90° shown in FIG. 8d so that the field strength is increased in some parts by >40%. Due to a possible exponential relationship between maximum of the field strength and ignition behaviour, such an increase of 40% might influence ignition behaviour disproportionately highly.

1. An ignition device with a laser light generating device for the coupling of laser light into a combustion chamber of the internal combustion engine, wherein the laser light generating device is configured to couple at least dichromatic laser light into a combustion chamber of an internal combustion engine.

2. The ignition device as claimed in claim 1, wherein the at least dichromatic laser light has in its power spectrum at least two local maxima which are separated from one another with regard to their wavelength.

3. The ignition device as claimed in claim 2, wherein the second maximum in the power spectrum occurs at a wavelength, which is at least 1.25 times, greater than the wavelength of the first maximum.

4. The ignition device as claimed in claim 2, wherein the wavelength spacing between the at least two maxima which are separated from one another in the power spectrum is at least greater than the greatest line width of the maxima at the respective half maximum amplitude of the respective maximum.

5. The ignition device as claimed in claim 2, wherein a first of the at least two maxima is located in a wavelength range between 1 μm and 0.2 μm and a second of the at least two maxima is located in a wavelength range between 10 μm and 1 μm.

6. The ignition device as claimed in claim 1, wherein the laser light generating device is configured to emit the at least dichromatic laser light in the form of at least one time-limited laser light pulse.

7. The ignition means as claimed in claim 1, wherein the laser light generating device is configured to emit at least two laser light pulses which are separated from one another in time and are per se limited in time, both laser light pulses having at least dichromatic laser light or the chronologically second laser light pulse having in its power spectrum at least one maximum which occurs at a wavelength different from the chronologically first laser light pulse.

8. The ignition device as claimed in claim 7, wherein a delay of between 10 ns and 200 ns is provided between the first and the second of the at least two laser light pulses which are separated from one another in time.

9. The ignition device as claimed in claim 6, wherein the at least one laser light pulse or at least one of the at least two laser light pulses which are separated from one another in time has (have) a duration of between 0.1 ns and 3 ns.

10. The ignition device as claimed in claim 1, wherein the laser light generating device has at least one pumped light source and at least one laser resonator which can be fed with pumped light from this pumped light source and also at least one combustion chamber window or a coupling optics for the combustion chamber.

11. The ignition device as claimed in claim 10, wherein the at least one laser resonator is pumped longitudinally.

12. The ignition device as claimed in claim 10, wherein the laser resonator has a resonator coupling mirror and a resonator decoupling mirror and, arranged therebetween, a laser-active medium and a Q-switch.

13. The ignition device as claimed in claim 10, wherein the laser light generating device for generating the dichromatic laser light has at least one medium having non-linear optical properties for frequency multiplication or parametric frequency conversion.

14. The ignition device as claimed in claim 13, wherein the medium having non-linear optical properties follows a laser resonator of the laser light generating device in the beam direction of the laser light.

15. The ignition device as claimed in claim 12, wherein the medium having non-linear optical properties is arranged in the laser resonator.

16. The ignition device as claimed in claim 15, wherein the medium is arranged between the resonator decoupling mirror and the Q-switch.

17. The ignition device as claimed in claim 1, wherein the laser light generating device for generating at least two laser light pulses which are separated from one another in time has an optically shorter path for one component of the laser light and a delay path, which is optically longer by comparison, for another component of the laser light.

18. The ignition device as claimed in claim 17, wherein it has for the delayed decoupling of the laser light into the delay path at least one delayed decoupling mirror which is semitransparent to laser light at least in certain regions and optionally for recoupling into the optically shorter path a delayed coupling mirror which is semitransparent to laser light at least in certain regions.

19. The ignition device as claimed in claim 17, wherein it has a polarization beam splitter for the delayed decoupling of the laser light into the delay path.

20. The ignition device as claimed in claim 1, wherein the laser light generating device for generating at least dichromatic laser light has at least two laser light sources which are suitable for coupling laser light having differing wavelengths into the combustion chamber.

21. An internal combustion engine comprising an ignition device as claimed in claim 1.
